(19) United States
(12) Patent Application Publication
(10) Pub. No.: US 2024/0106963 A1
(43) Pub. Date: Mar. 28, 2024

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Masayuki IWASAWA, Kanagawa (JP)

(73) Assignee: FUJIFILM Business Innovation Corp., Tokyo (JP)

(21) Appl. No.: 18/188,402

(22) Filed: Mar. 22, 2023

(30) Foreign Application Priority Data
Sep. 26, 2022 (JP) 2022-153052

(51) Int. Cl. H04N 1/60; G06T 7/90

(52) U.S. Cl. CPC H04N 1/60; G06T 7/90; G06T 2207/10024

(57) ABSTRACT

An information processing apparatus includes a processor configured to acquire color information of an image file as a printing target, and, in a case where colors represented by the acquired color information include a specific color associated with a replacement color, replace the specific color with the associated replacement color and output a result of the replacement.

### CROSS-REFERENCE TO RELATED APPLICATIONS

This application is based on and claims priority under 35 USC 119 from Japanese Patent Application No. 2022-153052 filed Sep. 26, 2022.

### BACKGROUND

### (i) Technical Field

The present disclosure relates to an information processing apparatus, a non-transitory computer readable medium storing an information processing program, and an information processing method.

### (ii) Related Art

JP2020-177473A discloses an information processing apparatus that requests an image forming apparatus to perform printing of a document displayed by application software and includes an operation reception unit, a first print data generation unit, a second print data generation unit, and a communication unit. The operation reception unit receives an object printed in a specific color by designating a first area in a document as a printing target. The first print data generation unit converts information regarding the first area received by the operation reception unit into first print data. The second print data generation unit converts the document as the printing target into second print data. The communication unit transmits the first print data and the second print data to an image forming apparatus.

### SUMMARY

Aspects of non-limiting embodiments of the present disclosure relate to an information processing apparatus, a non-transitory computer readable medium storing an information processing program, and an information processing method that receive a workload of a user as compared with a case where a cover to be replaced is designated for each printing.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to acquire color information of an image file as a printing target, and, in a case where colors represented by the acquired color information include a specific color associated with a replacement color, replace the specific color with the associated replacement color and output a result of the replacement.

### BRIEF DESCRIPTION OF THE DRAWINGS

Exemplary embodiment(s) of the present invention will be described in detail based on the following figures, wherein:

FIG. 1 is a diagram illustrating a schematic configuration of an image forming system according to the present exemplary embodiment;

FIG. 2 is a block diagram illustrating a configuration of a main part of an electrical system of an image forming apparatus according to the present exemplary embodiment;

FIG. 3 is a block diagram illustrating a configuration of a main part of an electrical system of an information processing apparatus according to the present exemplary embodiment;

FIG. 4 is a functional block diagram illustrating a functional configuration of each unit of the image forming system according to the present exemplary embodiment;

FIG. 5 is an explanatory diagram illustrating an example of a flow of a printing process executed by the information processing apparatus according to the present exemplary embodiment;

FIG. 6 is a flowchart illustrating an example of a flow of a process of replacing a specific color with a replacement color, which is executed by the information processing apparatus according to the present exemplary embodiment; and

FIG. 7 is a flowchart illustrating an example of a flow of a process of displaying a preview of an image in which the specific color is replaced with the replacement color, which is executed by the information processing apparatus according to the present exemplary embodiment.

### DETAILED DESCRIPTION

Hereinafter, an example of an exemplary embodiment of the present invention will be described in detail with reference to the drawings. The identical reference signs are denoted by the same or equivalent components and portions in the drawings. In addition, the dimensional ratios in the drawings are exaggerated for convenience of description and may differ from the actual ratios.

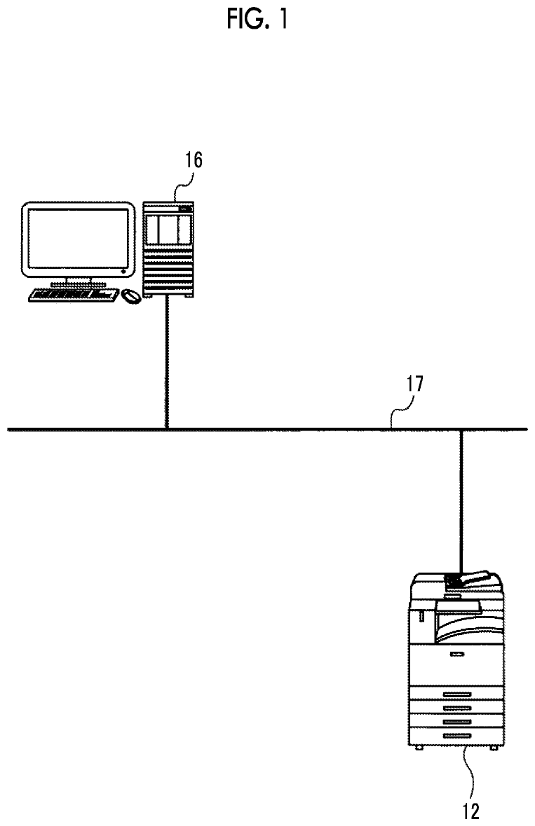

FIG. 1 is a diagram illustrating a schematic configuration of an image forming system according to the present exemplary embodiment. In the present exemplary embodiment, an image forming system 10 will be described as an example of an information processing system.

As illustrated in FIG. 1, the image processing system 10 according to the present exemplary embodiment includes an image forming apparatus 12 and an information processing apparatus 16. In the present exemplary embodiment, only one image forming apparatus 12 and one information processing apparatus 16 will be described, but a plurality of image forming apparatuses and a plurality of information processing apparatuses may be provided. Further, as the information processing apparatus 16, a personal computer may be applied, or a portable terminal such as a tablet terminal or a smartphone may be applied.

Each of the image forming apparatus 12 and the information processing apparatus 16 is connected to a communication line 17 such as a local area network (LAN) and an intranet.

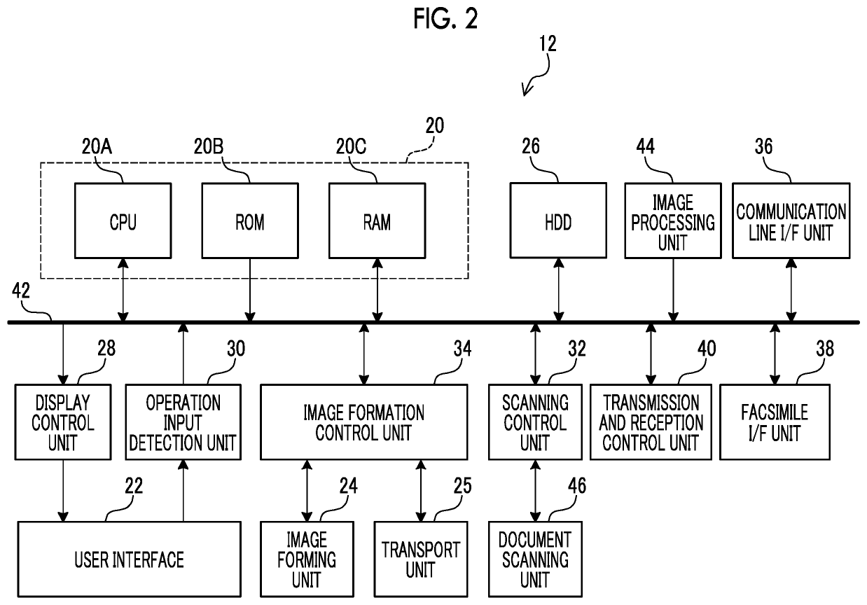

FIG. 2 is a block diagram illustrating the configuration of the main part of an electrical system of the image forming apparatus 12 according to the present exemplary embodiment.

As illustrated in FIG. 2, the image forming apparatus 12 according to the present exemplary embodiment includes a control unit 20 including a central processing unit (CPU) 20A, a read only memory (ROM) 20B, and a random access memory (RAM) 20C. The CPU 20A controls the overall operation of the image forming apparatus 12. The RAM 20C is used as a work area or the like during execution of various programs by the CPU 20A. Various control programs, various parameters, and the like are stored in advance in the ROM 20B. In the image forming apparatus 12, the components of the control unit 20 are electrically connected to each other by a system bus 42.

On the other hand, the image forming apparatus 12 according to the present exemplary embodiment includes a hard disk drive (HDD) 26 that stores various types of data, application programs, and the like. The image forming apparatus 12 further includes a display control unit 28 that is connected to the user interface 22 and controls display of various operation screens and the like on the display of the user interface 22. The image forming apparatus 12 further includes an operation input detection unit 30 that is connected to the user interface 22 and detects an operation instruction input via the user interface 22. In the image forming apparatus 12, the HDD 26, the display control unit 28, and the operation input detection unit 30 are electrically connected to the system bus 42. In the image forming apparatus 12 according to the present exemplary embodiment, an example including the HDD 26 will be described. The present invention is not limited to this, and the image forming apparatus 12 may include a non-volatile storage unit such as a flash memory.

The image forming apparatus 12 according to the present exemplary embodiment further includes a scanning control unit 32 and an image formation control unit 34. The scanning control unit 32 controls an optical image scanning operation by a document scanning unit 46 and a document feeding operation by a document transport unit. The image formation control unit 34 controls the image forming process by an image forming unit 24 and transport of paper to the image forming unit 24 by a transport unit 25. The image forming apparatus 12 further includes a communication line interface (communication line FF) unit 36 and an image processing unit 44. The communication line FF transmits and receives communication data to and from another external device including the information processing apparatus 16. The image processing unit 44 executes various image processes. The image forming apparatus 12 further includes a facsimile interface (facsimile FF) unit 38 that is connected to a telephone line (not illustrated) and performs transmission and reception of facsimile data to and from a facsimile device connected to the telephone line. The image forming apparatus 12 further includes a transmission and reception control unit 40 that controls transmission and reception of facsimile data via the facsimile interface unit 38. In the image forming apparatus 12, the transmission and reception control unit 40, the scanning control unit 32, the image formation control unit 34, the communication line interface unit 36, the facsimile interface unit 38, and the image processing unit 44 are electrically connected to the system bus 42. The image forming apparatus in the present disclosure is not limited to the above configuration.

With the above configuration, the image forming apparatus 12 according to the present exemplary embodiment executes an access to each of the RAM 20C, the ROM 20B, and the HDD 26 by the CPU 20A. In addition, the image forming apparatus 12 controls display of information such as an operation screen and various messages on the display of the user interface 22 via the display control unit 28 by the CPU 20A. In addition, the image forming apparatus 12 controls the operation of the document scanning unit 46 and the document transport unit via the scanning control unit 32 by the CPU 20A. In addition, the image forming apparatus 12 performs each of control of the operation of the image forming unit 24 and the transport unit 25 via the image formation control unit 34 and control of the transmission and reception of communication data via the communication line interface unit 36 by the CPU 20A. In addition, the image forming apparatus 12 controls transmission and reception of facsimile data via the facsimile interface unit 38 by the transmission and reception control unit 40 by the CPU 20A. Further, in the image forming apparatus 12, the CPU 20A grasps an operation content in the user interface 22 based on operation information detected by the operation input detection unit 30. The image forming apparatus 12 performs various controls based on the operation content. Forming an image on paper may be referred to as printing below.

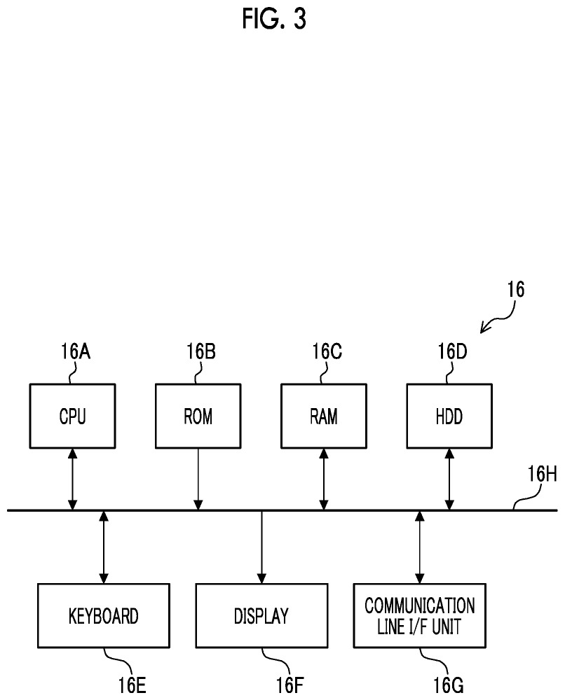

Subsequently, the configuration of a main part of an electrical system of the information processing apparatus 16 according to the present exemplary embodiment will be described. FIG. 3 is a block diagram illustrating the configuration of the main part of the electrical system of the information processing apparatus 16 according to the present exemplary embodiment. The information processing apparatus 16 basically has a general computer configuration.

As illustrated in FIG. 3, the information processing apparatus 16 according to the present exemplary embodiment includes a CPU 16A, a ROM 16B, a RAM 16C, an HDD 16D, a keyboard 16E, a display 16F, and a communication line interface (I/F) unit 16G. The CPU 16A controls the overall operation of the information processing apparatus 16. Various control programs, various parameters, and the like are stored in advance in the ROM 16B. The RAM 16C is used as a work area or the like during execution of various programs by the CPU 16A. Various types of data, application programs, and the like are stored in the HDD 16D. The keyboard 16E is used to input various types of information. The display 16F is used to display various types of information. The communication line interface unit 16G is connected to the communication line 17, and transmits and receives various types of data to and from another device including the image forming apparatus 12 connected to the communication line 17. The above units of the information processing apparatus 16 are electrically connected to each other by a system bus 16H. In the information processing apparatus 16 according to the present exemplary embodiment, an example including the HDD 16D will be described. The present invention is not limited to this, and the image forming apparatus 12 may include another non-volatile storage unit such as a flash memory.

With the above configuration, in the information processing apparatus 16 according to the present exemplary embodiment, the CPU 16A performs accesses to the ROM 16B, the RAM 16C, and the HDD 16D, acquisition of various types of data via the keyboard 16E, and display of various types of information on the display 16F. In addition, in the information processing apparatus 16, the CPU 16A controls transmission and reception of communication data via the communication line interface unit 16G. The CPU 16A corresponds to an example of a processor.

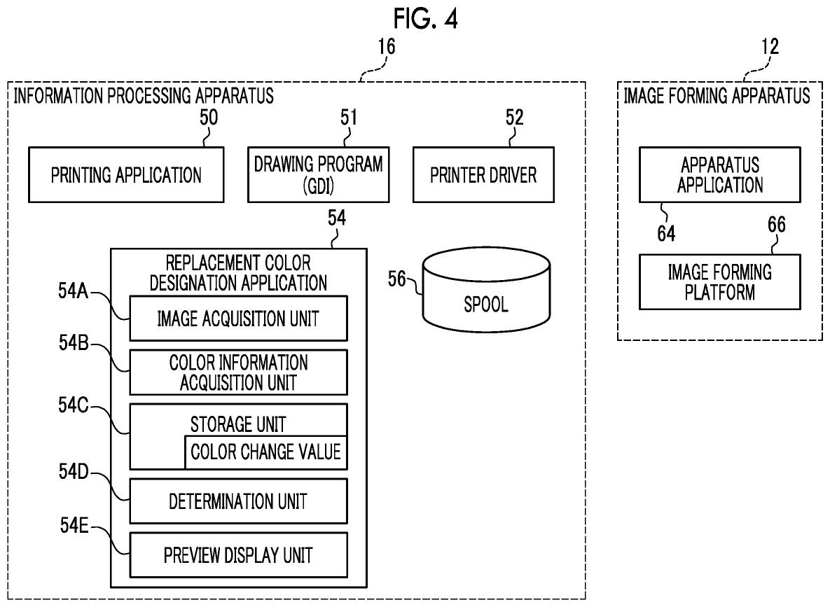

Next, a functional configuration of each unit of the image forming system 10 according to the present exemplary embodiment configured as described above will be described. FIG. 4 is a functional block diagram illustrating the functional configuration of each unit of the image forming system 10 according to the present exemplary embodiment.

Information Processing Apparatus 16

The information processing apparatus 16 has the functions of a printing application 50, a printer driver 52, and a replacement color designation application 54 by the CPU 16A executing the program.

The printing application 50 is an application having a printing function that operates on the information processing apparatus 16. As an example, the printing application 50 is a general-purpose application having a printing function.

The printer driver 52 creates print data as image data (in other words, data of an image file as a printing target) in accordance with an instruction of the printing application 50. The print data created by the printer driver 52 is temporarily stored in a spool 56. The print data (spool file) temporarily stored in the spool 56 is transferred to the image forming apparatus 12. The image forming apparatus 12 executes a printing process (in other words, an image forming process) based on the print data.

The replacement color designation application 54 acquires color information of print data from the printer driver 52. The replacement color designation application 54 instructs the printer driver 52 to replace a specific color with the associated replacement color and output a result of the replacement in a case where colors represented by the acquired color information include a specific color associated with the replacement color. The replacement color designation application 54 in the present exemplary embodiment is a resident application, but the present disclosure is not limited to this.

In addition, the replacement color designation application 54 has functions of an image acquisition unit 54A, a color information acquisition unit 54B, a storage unit 54C, a determination unit 54D, and a preview display unit 54E.

The image acquisition unit 54A captures an image of print data. Specifically, the printing application 50 captures a screen on which print data is drawn and displayed. For example, in a screen capture, by pressing a “capture” button displayed on a printing setting screen of the printing application 50, a screen on which print data is drawn and displayed is captured.

The color information acquisition unit 54B acquires the color information of the print data. In the present exemplary embodiment, the color information is acquired from a screen acquired by the image acquisition unit 54A.

The storage unit 54C stores a color change value for replacing the specific color with the replacement color. In this color change value, a specific color and a replacement color are associated with each print attribute value. The print attribute value referred to here includes at least the file name of an image file as a printing target and a user name of a user who starts the printing application 50.

Further, the association between the specific color and the replacement color may be stored in a storage device different from the HDD 16D in the information processing apparatus 16. For example, the association may be stored in a storage device outside the information processing apparatus 16 or may be stored in an external server.

The determination unit 54D performs determination to replace a specific color with a replacement color in a case where the colors represented by the color information of the captured screen include the specific color associated with the replacement color. Specifically, in a case where the association between the specific color and the replacement color in the user name is different from the association between the specific color and the replacement color in the file name, the determination unit 54D performs determination to give a priority to the association between the specific color and the replacement color in the file name. The replacement color designation application 54 instructs the printer driver 52 to replace the specific color with the replacement color associated with the replacement color and output the result of the replacement based on the determination of the determination unit 54D.

In a case where the colors represented by the color information of the captured screen include the specific color associated with the replacement color, the preview display unit 54E displays a preview by replacing the specific color with the associated replacement color based on the determination of the determination unit 54D. Specifically, the preview display unit 54E generates print data in which the specific color is replaced with the associated replacement color. Then, data for preview display is generated from the generated print data by a drawing program 51 (graphics device interface (GDI)) and the preview is displayed.

In a case where the replacement color is a spot color such as clear, gold, or silver, it is not possible to manage the replacement color by RGB or CMYK. Therefore, in the preview display, the specific color is replaced with an alternative color, and then output. On the other hand, in the case of a printing instruction, the specific color is replaced with the spot color which is the replacement color, and printing is performed.

The image forming apparatus 12 has the functions of an apparatus application 64 and an image forming platform 66 by the CPU 20A executing the program.

The apparatus application 64 executes a process of displaying a screen such as a process list on the user interface 22, and a function of transferring print data acquired from the information processing apparatus 16 or the printing application 50 to the image forming platform 66.

The image forming platform 66 provides basic functions as the image forming apparatus 12 such as display on the user interface 22 and image forming based on print data. For example, the image forming platform is configured by an application programming interface (API).

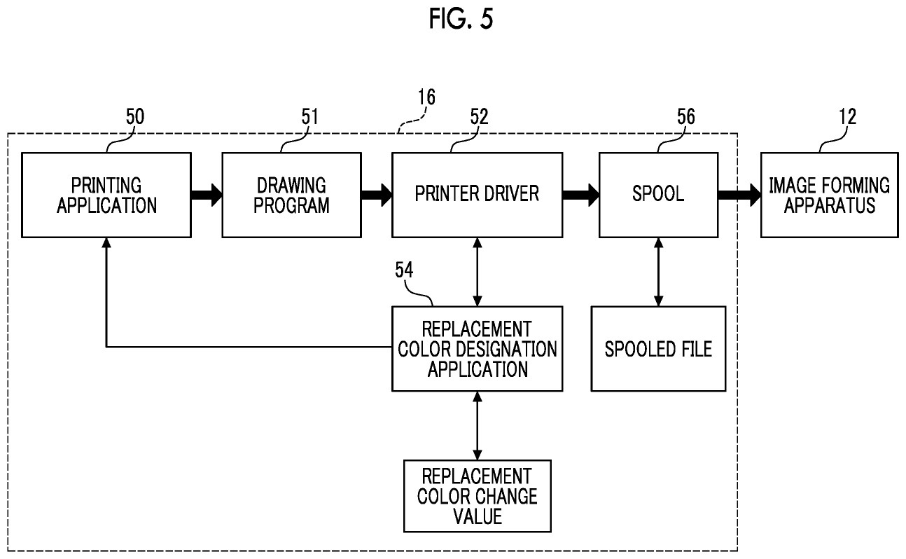

Next, a printing process in a case where the image forming apparatus 12 performs printing in the image forming system 10 according to the present exemplary embodiment will be described. FIG. 5 is a diagram for describing an example of the printing process in a case where the image forming apparatus 12 performs printing in the image forming system 10 according to the present exemplary embodiment.

As illustrated in FIG. 5, in a case where printing is started by the printing application 50, the printing application 50 calls the drawing program 51. The drawing program 51 generates data including information regarding drawing attributes for drawing on the image forming apparatus 12 from the print data. A DDI function of the printer driver 52 is called, and then the printer driver 52 generates a printer language, and transfers the printer language to the spool 56. The spool 56 outputs the generated printer language to the image forming apparatus 12 while spooling the generated printer language to a spool file. The image forming apparatus 12 performs printing of an image based on the output printer language.

Here, in the replacement color designation application 54, color information is acquired from an image file as a printing target, that is, print data. In a case where the colors represented by the acquired color information include a specific color associated with a replacement color, an instruction to replace the specific color with the associated replacement color and perform printing is output to the printer driver 52. In the replacement color designation application 54, in a case where the association between the specific color and the replacement color in the user name is different from the association between the specific color and the replacement color in the file name, an instruction to give a priority to the association between the specific color and the replacement color in the file name, replace the specific color with the replacement color based on the prioritized association, and perform printing is output to the printer driver 52.

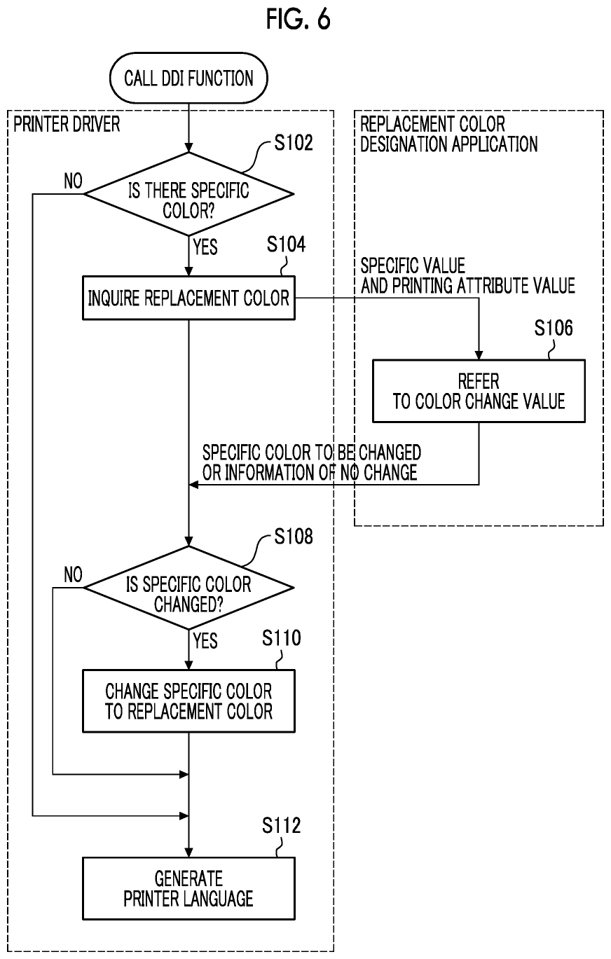

Next, a flow of replacing the specific color with the replacement color in the image forming system 10 according to the present exemplary embodiment will be described. FIG. 6 is a flowchart illustrating an example of a flow of a process of replacing a specific color with a replacement color, which is executed by the information processing apparatus according to the present exemplary embodiment.

In a case where printing is started in the printing application 50, data for drawing on the image forming apparatus 12 is generated from the print data by the drawing program 51. At this time, it is determined whether or not the print data includes the specific color (Step S102).

In a case where the print data includes the specific color, the printer driver 52 inquires the replacement color designation application 54 whether or not there is a replacement color associated with the specific color (Step S104). At this time, an inquiry is made by adding an attribute value of the image file as a printing target.

The replacement color designation application 54 that has received the inquiry refers to the color change value and determines whether or not there is a replacement color associated with the specific color (Step S106). In a case of changing the specific color to the replacement color as a result of the determination, the printer driver 52 is notified (instructed) of the replacement color. On the other hand, in a case where the specific color is not changed to the replacement color, the printer driver 52 is notified (instructed) that the specific color is not changed.

The printer driver 52 determines whether or not to change the specific color to the replacement color, based on the information of which a notification is received from the replacement color designation application 54 (Step S108).

In a case where it is necessary to change the specific color to the replacement color, the specific color is changed to the replacement color (Step S110).

Then, a printer language in which the specific color is changed to the replacement color is generated (Step S112), and the print data in which the specific color is replaced with the replacement color is transmitted to the image forming apparatus 12 by outputting the printer language to the spool 56.

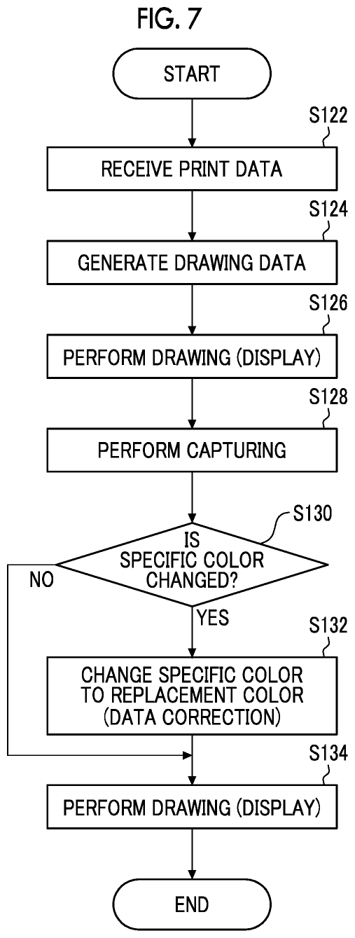

Next, a capturing function and a preview display function in the replacement color designation application 54 of the present exemplary embodiment will be described. FIG. 7 is a flowchart for describing from the capturing function to the preview display function of the replacement color designation application 54.

In a case where the printing application 50 is started and the print data is selected, the drawing program 51 receives the print data (Step S122).

The drawing program 51 generates drawing data from the received print data (Step S124).

The generated drawing data is displayed on the display of the information processing apparatus 16 (Step S126).

Then, in a case where the “preview” button of a setting screen of the printing application 50 is pressed, the screen displayed on the display is captured (Step S128).

Then, the color information is acquired from the captured screen, and it is determined whether or not there is the specific color (Step S130).

In a case where there is the specific color, the print data is corrected to data in which the specific color is replaced with the associated replacement color (Step S132).

Then, the corrected print data is transmitted to the drawing program 51, and the drawing program 51 generates drawing data from the corrected print data, and displays the generated drawing data on the display of the information processing apparatus 16 (Step S134).

In this manner, the image in which the specific color is replaced with the associated replacement color is displayed as a preview on the display.

Next, the operation of the present exemplary embodiment will be described.

In the information processing apparatus 16, the replacement color designation application 54 acquires color information from the print data, and, in a case where the colors represented by the acquired color information include a specific color associated with the replacement color, an instruction is output to the printer driver 52 that replaces the specific color with the associated replacement color and outputs the result of the replacement. Therefore, in the information processing apparatus 16, it is possible to reduce a workload of the user as compared with a case where a color to be replaced is designated for each printing.

Further, in the information processing apparatus 16, a print job includes the attribute value, and each attribute value is stored in the storage unit 54C in a state of being associated with the specific color and the replacement color. Here, the replacement color designation application 54 acquires an attribute value from the printer driver 52 that has received the print job, and outputs an instruction to replace a specific color with a replacement color, in accordance with the association between the specific color and the replacement color in the acquired attribute value. Therefore, in the information processing apparatus 16, it is possible to reduce the workload of the user as compared with a case where the specific color and the replacement color are not associated with each attribute value.

Further, since the attribute value includes at least one of the user name or the file name, in the information processing apparatus 16, it is possible to associate the specific color and the replacement color for each user or each file.

Further, in the information processing apparatus 16, in a case where the association between the specific color and the replacement color in the user name is different from the association between the specific color and the replacement color in the file name, the replacement color designation application 54 outputs, to the printer driver 52, an instruction to give a priority to the association between the specific color and the replacement color in the file name and replace the specific color with the replacement color. Therefore, in the information processing apparatus 16, it is possible to reduce the work load of the user at the time of printing, as compared with the case where the association between the specific color and the replacement color in the user name is prioritized.

Further, in the information processing apparatus 16, information regarding the association between the specific color and the replacement color is stored in an external storage device. In this case, a plurality of users may use the association between the specific color and the replacement color, as compared with a case where the association between the specific color and the replacement color is stored only in the information processing apparatus 16.

Further, in the information processing apparatus 16, the replacement color designation application 54 has the function of capturing a screen on which an image file is displayed and acquiring the color information of the image file. Therefore, the user may visually select the image to be printed, as compared with the case where the color information is acquired without displaying the image file.

Further, the information processing apparatus 16 has a function of replacing a specific color with a replacement color and displaying a preview in a case where the specific color is provided in the screen captured by the replacement color designation application 54. Thus, the user may visually check that the specific color is replaced with the replacement color (color conversion is performed) in comparison to a case where the preview is displayed without changing the specific color in the captured screen.

In the above exemplary embodiment, the replacement color designation application 54 has a capturing function and a preview display function, but the present disclosure is not limited to this configuration. The replacement color designation application 54 may or may not have both a capturing function or a preview display function.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processes executed by the units of the image forming system 10 according to the above exemplary embodiment may be processes executed by software, processes executed by hardware, or a combination of both cases. The processes executed by the units of the image forming system 10 may be stored in a storage medium as a program and distributed.

The present disclosure is not limited to the above description, and can be variously modified and implemented in a range without departing from the gist of the present invention.

The present disclosure is not limited to the above-described exemplary embodiment, and various modifications, changes, and improvements can be made within a range without deviating from the gist thereof. For example, a plurality of the modification examples described above may be combined and configured as appropriate.

Additional Notes
(((1)))

An information processing apparatus comprising:
a processor configured to:
   acquire color information of an image file as a printing target; and
   in a case where colors represented by the acquired color information include a specific color associated with a replacement color, replace the specific color with the associated replacement color and output a result of the replacement.
(((2)))

The information processing apparatus according to (((1))),
wherein a print job includes an attribute value,
a specific color and a replacement color are associated with each attribute value, and
the processor is configured to:
   acquire the attribute value from the print job; and
   replace the specific color with the replacement color in accordance with an association between the specific color and the replacement color in the acquired attribute value.
(((3)))

The information processing apparatus according to (((2))), wherein the attribute value includes at least one of a user name or a file name.
(((4)))

The information processing apparatus according to (((3))), wherein the processor is configured to:
in a case where an association between the specific color and the replacement color in the user name is different from an association between the specific color and the replacement color in the file name, give a priority to the association between the specific color and the replacement color in the file name.
(((5)))

The information processing apparatus according to any one of (((1))) to (((4))), wherein an association between the specific color and the replacement color is stored in an external storage device.
(((6)))

The information processing apparatus according to any one of (((1))) to (((5))), wherein the processor is configured to:
acquire the color information of the image file from a screen on which the image file is displayed.
(((7)))

The information processing apparatus according to any one of (((1))) to (((6))), wherein the processor is configured to:
replace the specific color in the screen on which the image file is displayed with the associated replacement color, and display a preview.
(((8)))

A non-transitory computer readable medium storing an information processing program causing a computer to execute a process comprising:
acquiring color information of an image file as a printing target; and
replacing, in a case where colors represented by the acquired color information include a specific color associated with a replacement color, the specific color with the associated replacement color and outputting a result of the replacement.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire color information of an image file as a printing target; and
in a case where colors represented by the acquired color information include a specific color associated with a replacement color, replace the specific color with the associated replacement color and output a result of the replacement.

2. The information processing apparatus according to claim 1,
wherein a print job includes an attribute value,
a specific color and a replacement color are associated with each attribute value, and
the processor is configured to:
acquire the attribute value from the print job; and
replace the specific color with the replacement color in accordance with an association between the specific color and the replacement color in the acquired attribute value.

3. The information processing apparatus according to claim 2,
wherein the attribute value includes at least one of a user name or a file name.

4. The information processing apparatus according to claim 3, wherein the processor is configured to:
in a case where an association between the specific color and the replacement color in the user name is different from an association between the specific color and the replacement color in the file name, give a priority to the association between the specific color and the replacement color in the file name.

5. The information processing apparatus according to claim 1,
wherein an association between the specific color and the replacement color is stored in an external storage device.

6. The information processing apparatus according to claim 1, wherein the processor is configured to:
acquire the color information of the image file from a screen on which the image file is displayed.

7. The information processing apparatus according to claim 6, wherein the processor is configured to:
replace the specific color in the screen on which the image file is displayed with the associated replacement color, and display a preview.

8. A non-transitory computer readable medium storing an information processing program causing a computer to execute a process comprising:
acquiring color information of an image file as a printing target; and
replacing, in a case where colors represented by the acquired color information include a specific color associated with a replacement color, the specific color with the associated replacement color and outputting a result of the replacement.

9. An information processing method comprising:
acquiring color information of an image file as a printing target; and
replacing, in a case where colors represented by the acquired color information include a specific color associated with a replacement color, the specific color with the associated replacement color and outputting a result of the replacement.
